(19) United States
(12) Patent Application Publication
(10) Pub. No.: US 2025/0245992 A1
(43) Pub. Date: Jul. 31, 2025

(54) MULTI-CART SEPARATION WITH DEPTH ESTIMATION AND OBJECT DETECTION

(71) Applicant: Walmart Apollo, LLC, Bentonville, AR (US)

(72) Inventors: Xin Ma, Arlington, TX (US); Feiyun Zhu, Plano, TX (US); Wei Wang, Dallas, TX (US); Lingfeng Zhang, Flower Mound, TX (US); Mingquan Yuan, Flower Mound, TX (US); Zhaoliang Duan, Frisco, TX (US); Han Zhang, Allen, TX (US); Colin Grant Mitchell, Wills Point, TX (US); Yanmei Jin, Dallas, TX (US); Huanyu Zang, Frisco, TX (US); William Craig Robinson, Centerton, AR (US)

(21) Appl. No.: 19/035,555

(22) Filed: Jan. 23, 2025

Related U.S. Application Data
(60) Provisional application No. 63/625,714, filed on Jan. 26, 2024.

(51) Int. Cl. G06V 20/52; G06T 7/50; G06V 10/25; G06V 10/764; G07G 1/00

(52) U.S. Cl. CPC G06V 20/52; G06T 7/50; G06V 10/25; G06V 10/764; G07G 1/0036; G06T 2207/20081; G06T 2207/30232

(57) ABSTRACT

Examples provide for multi-cart separation using computer vision object detection and depth estimation. An image capture device associated with a checkout terminal in a retail facility generates images of shopping carts near the checkout terminal. A pre-trained cart detection model analyzes the images and detects the carts in each image. The detected carts are identified by bounding boxes in the image data of the images. A depth estimation model generates a depth map based on the image data. The depth map and bounding boxes are combined to create depth values for each cart in the images. The depth values are normalized. The normalized depth values are used to identify an active cart currently checking out at the checkout terminal in real-time. A multi-cart data set is annotated with an active cart label corresponding to the identified active cart to identify active and inactive carts in bottom camera images with greater accuracy.

### BACKGROUND

Computer vision object detection and recognition can be used to automatically analyze images of shopping carts and identify products in each customer's cart. This can be used to enable a customer to checkout without scanning each individual item in the cart or to verify that all items in the cart were scanned after the customer has completed checkout to reduce shrink. However, there are frequently multiple shopping carts near the same checkout terminal at the same time. This makes it difficult to determine which shopping cart is actively checking out at a given checkout terminal as opposed to other carts within the field of view of the camera generating the images of the carts which are near the checkout terminal but not actively checking out at the checkout terminal. A human user can manually scan items in each shopping cart to manually verify cart contents and items on the customer receipts. However, this method can be a laborious and time-consuming process for the human user, as well as creating additional friction for customers ready to exit the store.

### SUMMARY

Some examples provide a system and method for multi-cart separation using computer vision object detection and depth estimation on image data. One or more images of a plurality of carts generated by a bottom camera associated with a checkout terminal in a retail environment are analyzed by a pre-trained cart detection model and a depth estimation model in real-time. The pre-trained cart detection model generates a set of bounding boxes identifying each cart in the plurality of carts. The depth estimation model generates a depth map. The depth map and the bounding boxes are combined to calculate a normalized depth value for each cart in the plurality of carts. The normalized depth values are used to identify an active cart and any inactive carts in the plurality of carts. The active cart is the cart predicted to be currently checking out at the checkout terminal. The image data is annotated with labels identifying the active cart and any inactive carts.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for multi-cart separation using object detection and depth estimation.

FIG. 2 is an exemplary block diagram illustrating a retail facility including a plurality of image capture devices for generating images of a plurality of carts associated with a plurality of checkout terminals.

FIG. 3 is an exemplary block diagram illustrating a cart separation manager for performing cart separation using object detection results and depth estimation

FIG. 4 is an exemplary flow chart illustrating operation of the computing device to identify an active cart from a plurality of carts captured in an image.

FIG. 5 is an exemplary flow chart illustrating operation of the computing device to infer an active cart based on object detection and depth estimation results.

FIG. 6 is an exemplary flow chart illustrating operation of the computing device to label an active cart in an image including a plurality of carts using cart detection bounding boxes and a depth map.

FIG. 7 is an exemplary unannotated image of a bottom portion of an active cart in a multi-cart data set.

FIG. 8 is an exemplary annotated image of a bottom portion of an active cart and an inactive cart.

FIG. 9 is an exemplary unannotated image of a bottom portion of two inactive carts in an absence of an active cart.

FIG. 10 is an exemplary annotated image of a bottom portion of two inactive carts in an absence of an active cart.

FIG. 11 is an exemplary image of a bottom portion of an active cart without any inactive carts present in the image.

FIG. 12 is an exemplary depth map associated with an image of a plurality of carts generated by a depth estimation model.

FIG. 13 is an exemplary line graph for a depth threshold determination in accordance with a multi-cart data set.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Computer vision object detection and recognition can be used to analyze images of products and other objects within a store, warehouse, distribution center or other retail facility to automatically identify products, signs, location tags, shelving, and other objects of interest using input images of the objects. Computer vision object detection and recognition can be used to identify shopping carts and/or products in a shopping cart automatically without human intervention. However, during crowded situations in a retail environment, it is a common occurrence for cameras to capture multiple shopping carts simultaneously at each checkout terminal. A retail environment is any type of environment including a retail facility, such as a store, distribution center, warehouse, or other facility.

To ensure accurate and dedicated item detection and recognition for each customer during the checkout process, it becomes crucial to develop a system that can effectively separate different shopping carts. The integration of depth estimation and object detection capabilities in the bottom camera can be instrumental in resolving this issue.

Referring to the figures, examples of the disclosure enable multi-cart separation using computer vision and depth estimations. In some examples, a cart separation manager combines bounding box data for carts detected in images by a pre-trained object detection model with a depth map generated by a depth estimation model to generate per-cart normalized depth values bounded within a region of values, such as values between zero and one. In this manner, the system enables accurate separation of active carts and inactive carts based on distance of each cart from a checkout terminal using image data generated by a bottom camera. This enable fast, efficient and accurate identification and isolation of an active cart near a checkout terminal using an image containing multiple shopping carts.

Other examples enable labeling of active carts and inactive carts in image data generated by a bottom camera. The active carts are analyzed to identify the cart contents of the cart actively checking out and the contents of inactive carts are ignored or discarded. This reduces processor and memory usage expended in detecting and recognizing items in inactive carts which are not of interest to the system for more efficient and accurate management of object detection and recognition results with reduced error rate.

Still other embodiments enable annotating image data with active cart labels and inactive cart labels enabling the system to automatically identify an active cart in an image containing multiple carts in a crowded space. In this manner, only an active cart image is isolated and analyzed to verify cart contents at checkout without requiring a human user to manually scan each item. This saves time, reduces labor, and improves customer satisfaction and convenience at checkout.

The computing device operates in an unconventional manner by separating active carts from inactive carts in images generated by a bottom camera near a checkout terminal, enabling the system to discard or otherwise ignore the inactive carts. In this manner, the system is used in an unconventional manner by eliminating the need to analyze image data and identify contents of every cart in an image, and allows the system to ignore inactive carts, reducing the number of carts and items in carts for the system to analyze and identify using the image data, thereby improving the functioning of the underlying computer by reducing the system resources expended on analyzing the contents of inactive carts which are not of interest to the system, such as by reducing processor usage, memory usage, and network bandwidth usage consumed during computer vision object detection and recognition analysis.

The system in other examples outputs a result to a user via a user interface device identifying the active cart. This enables faster and more efficient identification of active carts in images for reduced processor load, reduced network bandwidth usage, improved user efficiency via UI interaction, and increased user interaction performance.

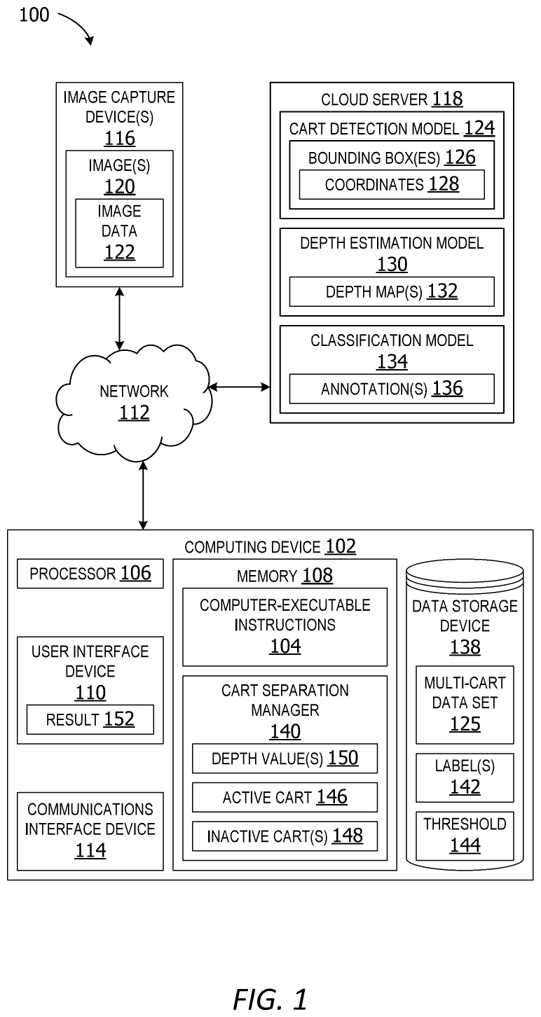

Referring again to FIG. 1, an exemplary block diagram illustrates a system 100 for multi-cart separation using object detection and depth estimation. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

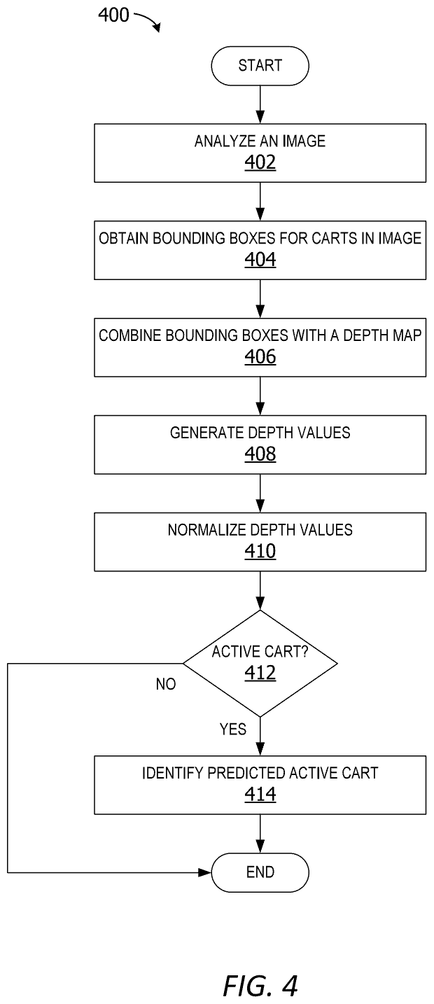

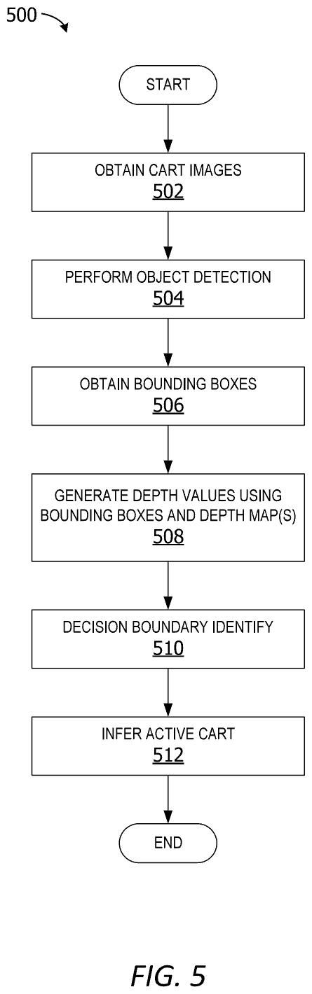

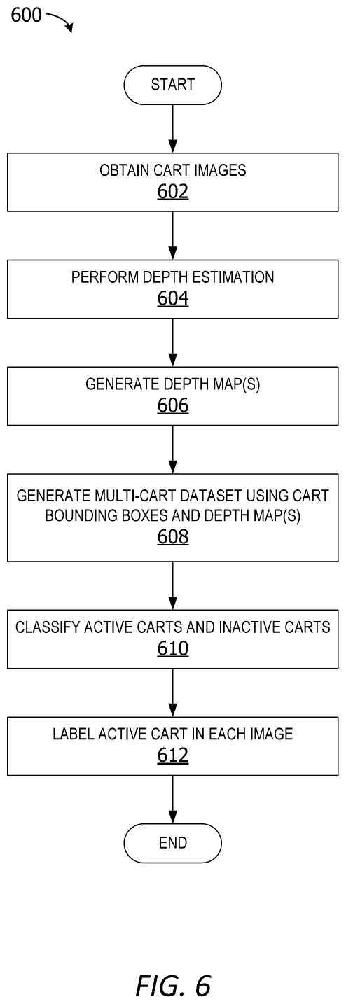

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 4, FIG. 5, and FIG. 6).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to one or more image capture device(s) 116 and/or a cloud server 118, can occur using any protocol or mechanism over any wired or wireless connection. In some examples, the communications interface device 114 is operable with short range communication technologies such as by using near-field communication (NFC) tags.

The one or more image capture device(s) 116 include any type of device for generating one or more digital image(s) 120 of shopping carts located within a field of view (FOV) of the one or more image capture device(s) 116. The image data 122 associated with the image(s) 120 incudes the image metadata, such as the date and/or time when the image is generated. The image data 122 optionally also includes identification data associated with the image capture device that generated the image. The images generated by a given image capture device including the same set of shopping carts forms a multi-cart data set 125. In some examples, the image capture device(s) 116 include a bottom camera for capturing images of a bottom portion of one or more shopping carts within the FOV of the bottom camera. The multi-cart data set 125 is a set of data used to identify an active cart 146, if present, in one or more image(s) 120.

In this example, the multi-cart data set 125 includes the image data 122 for one or more image(s) including a set of one or more shopping carts within the FOV of the same bottom camera in the set of one or more image capture device(s) 116. However, the multi-cart data set 125 is not limited to image data 122. The multi-cart data set 125 in other embodiments also includes annotation(s) 136, one or more cropped images of a detected shopping cart, label(s) 142 identifying the active cart 146 and any inactive cart(s) 148 in a given image, as well as any other data used by the cart separation manager 140 to detect and separate shopping carts using one or more images of one or more shopping carts generated by a bottom camera.

The cloud server 118 is a logical server providing services to the computing device 102 or other clients. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The cloud server 118 in this example includes a cart detection model 124. The cart detection model 124 is a pre-trained object detection model which has been trained to detect shopping carts in images, such as the image(s) 120. The cart detection model 124 is a computer vision, pre-trained, deep learning convolutional neural network (CNN) model. The cart detection model is trained to detect shopping carts in images using labeled training data including labeled shopping carts. In this example, the cart detection model is a you only look once (YOLO) deep learning model, such as, but not limited to, a YOLO version five (v5) pre-trained object detection model trained on a custom labeled dataset to accurately identify shopping carts in one or more images.

The cart detection model 124 analyzes the image(s) 120 and places bounding box(es) 126 around each detected shopping cart. Each bounding box is associated with a set of coordinates 128 corresponding to a location of the image of the shopping cart in the digital image being analyzed. Objects other than the shopping cart(s) enclosed within the bounding box(es) 126 are cropped from the image(s) 120.

In these embodiments, the image(s) 120 do not include images of users or other individuals within the retail facility. Any images having human users or other objects which are not of interest, such as objects other than shopping carts and items in the shopping carts, inadvertently included within the image(s) 120 are removed from the image(s) by cropping the images such that only objects of interest remain in the cropped images. Images of users or objects which are not of interest are deleted or otherwise discarded. The cropped images containing only the objects of interest remaining in the image data 122 are then analyzed to identify and label the objects of interest within the cropped images.

The cart detection model 124 in this example is implemented on the cloud server 118. However, in other embodiments, the cart detection model 124 is implemented on the computing device 102, such as, but not limited to, a server located within a retail facility or other on-site (local) server.

A depth estimation model 130 analyzes the image(s) 120 to generate one or more depth map(s) 132. The depth estimation model in this example is a trained, deep learning, ML model. In other examples, the depth estimation model can be implemented as a transformer model, however, transformer models may have insufficient speed for the system requirements.

In this example, the depth estimation model generates a depth map for each image in the one or more image(s) 120. The depth map includes distance information for objects in each image, such as the shopping carts in each image. Each depth map in the depth map(s) 132 describes distance information for pixels in each corresponding image from the viewpoint of the image capture device that generated the image.

In this example, the depth estimation model 130 is implemented on the cloud server 118 with the cart detection model. However, in other embodiments, the depth estimation model 130 is implemented on a different cloud server than the cloud server 118 implementing the cart detection model. In still other embodiments, the depth estimation model 130 is implemented on the computing device 102.

The cloud server 118, in this example, includes a classification model 134. The classification model 134 is a pre-trained machine learning (ML) model for identifying an active cart 146 and any inactive cart(s) 148 in the image(s) 120. The classification model may include pattern recognition or other ML algorithms to analyze the image data 122 and/or depth value(s) 150 associated with the detected carts in the image(s) 120 to label the cart(s) as active carts currently checking out at a given checkout terminal or inactive carts in the FOV of the image capture device but not actively checking out at the checkout terminal. In some examples, the classification model 134 compares one or more depth values for carts using a threshold 144 range of depth values to identify and label the active cart 146 and any inactive cart(s) 148 in the image data 122.

The classification model 134, in this example, adds annotations to the multi-cart data set 125 and/or the image data 122 for each image in the set of image(s) 120. The annotations identify the active cart 146 with an active cart label and any inactive cart(s) 148 with an inactive cart label, such as, but not limited to, the label(s) 142. The label(s) 142 include any type of label in the multi-cart data set 125 and/or the image data 122 used to distinguish the active cart 146 currently at the checkout terminal (nearest the checkout terminal) in an image from inactive (unchecked) carts in the image. In one example, the active cart, if present, is labeled with a number one “1” and any inactive carts are labeled with a zero “0.” However, the embodiments are not limited to labels of zeros and ones. In other embodiments, the active and inactive carts can be labeled with words, letters, symbols, colors, boxes, circles, etc.

The system 100 can optionally include a data storage device 138 for storing data, such as, but not limited to the multi-cart data set 125, the label(s) 142, a threshold 144, image data 122, bounding box coordinates 128, depth map(s) 132, depth value(s) 150 and/or any other type of data associated with identifying an active cart 146 and/or inactive cart(s) 148 using image(s) 120 generated by a bottom camera in the image capture device(s) 116. The threshold 144 is a range of depth values used to identify active carts based on the depth value for each shopping cart in each image. However, the embodiments are not limited to a threshold that is a range of values. In other examples, a customized threshold maximum depth value and/or a customized threshold minimum depth value is calculated for each multi-cart data set 125 associated with each set of images generated by a given bottom camera. In this example, the customized threshold is compared with the depth values for each cart to determine whether a given cart is close enough to the checkout terminal to predict or infer that the cart is the active cart at the checkout terminal.

The data storage device 138 can include one or more different types of data storage devices, such as, for example, one or more rotating disks drives, one or more solid state drives (SSDs), and/or any other type of data storage device. The data storage device 138 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 138 includes a database.

The data storage device 138 in this example is included within the computing device 102, attached to the computing device, plugged into the computing device, or otherwise associated with the computing device 102. In other examples, the data storage device 138 includes a remote data storage accessed by the computing device via the network 112, such as a remote data storage device, a data storage in a remote data center, or a cloud storage.

The memory 108, in this example, stores the cart separation manager 140. When executed by the processor 106 of the computing device 102, the cart separation manager 140 obtains an image from an image capture device. The pre-trained cart detection model 124 analyzes the image and generates a set of bounding boxes identifying each detected cart in a set of detected carts within the image. The depth estimation model 130 analyzes the image and generates a depth map for the set of detected carts within the image. The cart separation manager 140 obtains the depth map and the bounding box coordinates for each detected cart. In this example, the bounding box coordinates are provided within the image data 122. The cart separation manager 140 combines the bounding box data and the depth map data to generate a depth value for each detected cart in the image. The depth value(s) 150 are normalized using region information associated with the image to constrain the depth values within a predetermined range for each cart. The cart separation manager 140 provides the normalized depth value(s) to the classification model 134. The classification model 134 adds annotation(s) to the image data identifying the active cart 146 and any inactive cart(s) 148. The image can include only a single active cart or no active cart. The image can include no inactive carts, a single inactive cart, as well as two or more inactive carts. A result 152 is optionally generated and provided to another component and/or output to a user via the user interface device 110. The result 152 is a notification including a labeled image of the set of detected carts. If an active cart is present, the result 152 image includes an active cart label associated with the active cart. If one or more inactive carts are identified, the result includes an inactive cart label indicating each inactive cart.

In this example, both active and inactive carts are labeled in the result 152. However, in other examples, the result 152 includes one or more cropped images of the active cart without any images of the inactive carts present. In this example, the inactive cart images are cropped out and discarded.

The result 152 in this example is presented to a user via the user interface device 110. However, the embodiments are not limited to presenting the results to a user. In other embodiments, the result 152 is transmitted to another software component, computing device or cloud server via the communications interface device 114 for use in verifying items in a customer's shopping cart, verifying all items in the active cart appear on the checkout receipt, or other actions to reduce shrink and improve the customer experience during checkout and exit from the retail facility.

In this example, the cart detection model 124, the depth estimation model 130 and the classification model 134 are implemented on the cloud server 118. However, the embodiments are not limited to implementation of these components on the cloud server. In other embodiments, the cart detection model 124, the depth estimation model 130 and/or the classification model 134 are implemented on the computing device as part of the cart separation manager 140. In still other embodiments, the cart detection model 124, the depth estimation model 130 and/or the classification model 134 are implemented on the computing device 102 with the cart separation manager 140, but remain separate components operating in conjunction with the cart separation manager 140.

The cart separation manager 140 in this example is implemented on the computing device 102. In this example, the computing device 102 is a local server in the retail facility. However, the cart separation manager 140 in other embodiments is optionally implemented on a remote server which is not located in the retail facility and/or implemented on the cloud server 118.

The cart separation manager 140 in this example analyzes multi-cart data to identify an active cart located within a predetermined range of the checkout terminal (actively checking out) and a set of inactive carts, if any, in one or more images using object detection data (bounding boxes) and depth map information to generate normalized depth values for each cart used to predict the active cart and inactive carts. In this example, the active cart is a cart including one or more items in the cart, which is currently checking out at the checkout terminal, about to begin checking out at the checkout terminal or completing checkout at the checkout terminal. The active cart does not include an empty cart, abandoned cart or cart associated with a customer that is not at checkout.

However, in other embodiments, the active cart includes a cart which has completed checkout, but which is still currently positioned at the checkout terminal, such as where a cart is abandoned at the checkout terminal after the checkout is complete. In such cases, the cart separation manager 140 optionally identifies the cart as an inactive cart if no items are detected in the cart and the cart has remained stationary for a predetermined period of time. The predetermined period of time is a user-configurable threshold time period. If the cart remains stationary for the threshold time period, the active cart is re-designated an inactive cart.

In this example, the images generated by the image capture device(s) 116 are transmitted to the cloud server and/or the computing device 102. However, in other examples, the images may be stored in a data storage device, such as, but not limited to, the data storage device 138. Likewise, the depth map(s) may also be stored on the data storage device.

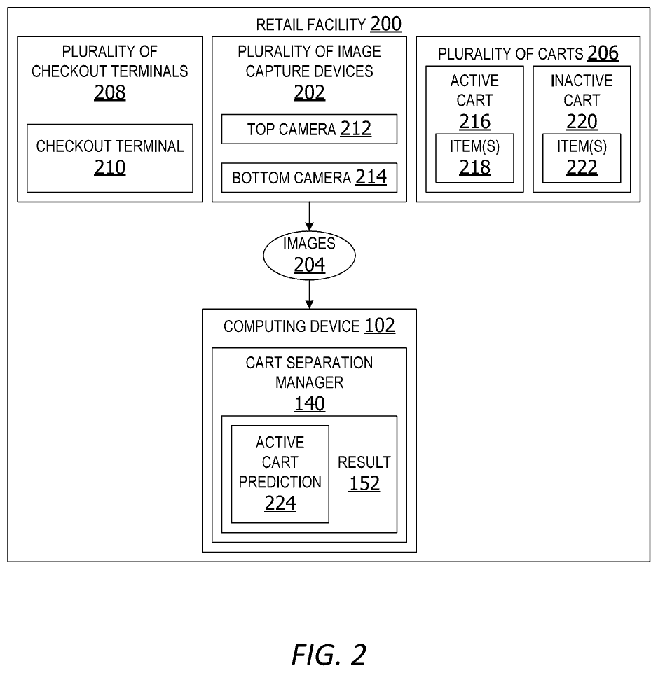

FIG. 2 is an exemplary block diagram illustrating a retail facility 200 including a plurality of image capture devices 202 for generating images 204 of a plurality of carts 206 associated with a plurality of checkout terminals 208. The retail facility 200 is a facility such as a store. The retail facility 200 can include indoor spaces, outdoor spaces and/or spaces which are partially enclosed and partially unenclosed.

The plurality of checkout terminals 208 includes one or more checkout terminals for checking out a basket of items in a purchase transaction, such as, but not limited to, the checkout terminal 210. The checkout terminal 210 can be implemented as a point-of-sale (POS) device staffed by a store employee, a self-checkout (SCO) terminal enabling customer self-checkout, and/or a scan and go (SNG) terminal enabling automated checkout using computer vision object detection and analysis on one or more images of the contents of the customer cart generated by one or more cameras positioned above the customer cart and/or on the side of the customer cart, such as, but not limited to, a top camera 212 mounted to a ceiling above the customer cart, an arch structure or tunnel through which the customer cart passes or other fixture enabling the top camera 212 to capture a bird's eye view image of the customer cart contents.

The plurality of image capture device(s) 202 in this example includes at least one top camera 212 and at least one bottom camera 214. The bottom camera 214 in this example, is a camera removably mounted to a bottom portion of the checkout terminal 210 such that a bottom portion of one or more shopping carts near the checkout terminal 210 is within the FOV of the bottom camera 214. The bottom camera generates a series of images of an area in the FOV of the bottom camera. In this example, the images 204 generated by the bottom camera 214 include a plurality of shopping carts 206.

In this example, the bottom camera 214 is mounted to a portion of the checkout terminal 210. In other embodiments, the bottom camera 214 is integrated into a bottom portion of the checkout terminal. In still other embodiments, the bottom camera 214 is mounted to a fixture in a position near the floor such that a bottom portion of the plurality of carts 206 is within the FOV of the bottom camera 214.

The plurality of carts 206 in this example includes an active cart 216 containing one or more item(s) 218 within the cart or on the cart. The active cart is a cart actively in the process of checking out at the checkout terminal 210, about to begin the process of checking out at the checkout terminal or completing the checkout process at the checkout terminal. However, in some cases, the images 204 may not include any active carts at the checkout terminal. In such cases, the images 204 do not show any carts within the threshold range of the checkout terminal.

The plurality of carts 206, in this example, includes a set of one or more inactive cart(s) 220. An inactive cart is a cart within the FOV of the bottom camera, but which is not actively checking out at the checkout terminal 210. An inactive cart can include a cart having one or more item(s) 222 in the cart that is waiting in line to checkout at the checkout terminal 210. An inactive cart also includes any cart that is within the FOV of the bottom camera which is simply passing by the checkout terminal but not waiting to checkout. An inactive cart can also include an abandoned cart that is no longer being used by a customer.

The images 204 generated by the bottom camera 214 are transmitted to the cart separation manager 140 on the computing device 102 via a network, such as, but not limited to, the network 112 in FIG. 1. The cart separation manager analyzes the images 204 to identify the active cart and generate a result 152 including an active cart prediction 224. The active cart prediction 224 in this example includes annotated image data in which the active cart and any inactive carts are labeled. In other examples, the result includes a cropped image of the active cart with the inactive carts cropped out and discarded.

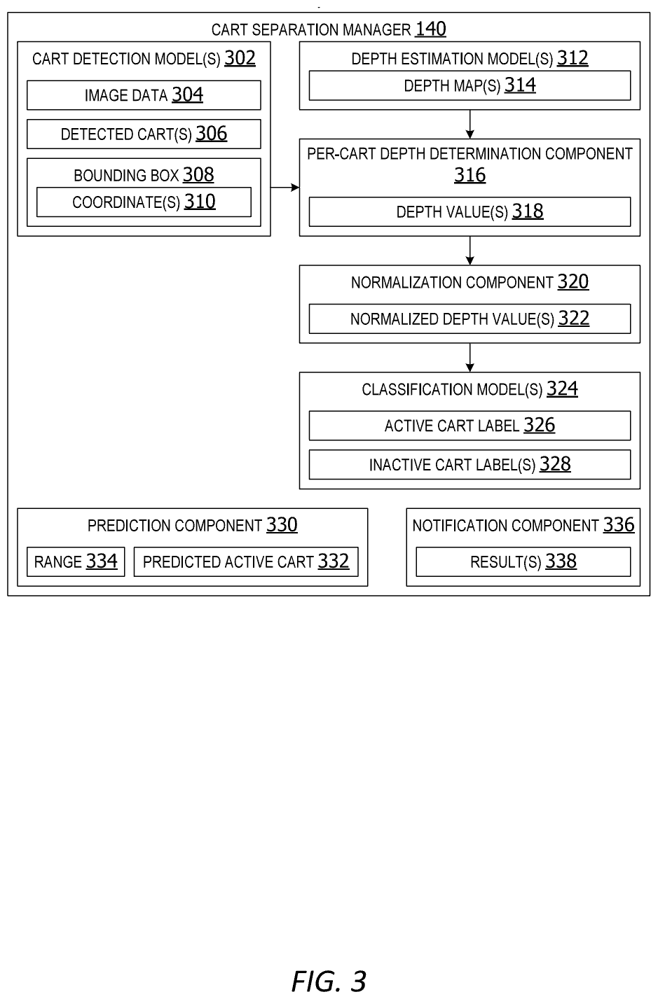

Turning now to FIG. 3, an exemplary block diagram illustrating a cart separation manager 140 for performing cart separation using object detection results and depth estimation is shown. In this example, the cart separation manager 140 includes one or more pre-trained cart detection model(s) 302, such as, but not limited to, the cart detection model 124 in FIG. 1. The cart detection model(s) 302 analyze the image data 304 associated with one or more images generated by a bottom camera to identify a set of one or more detected cart(s) 306. The cart detection model(s) 302 generate a bounding box 308 around each detected cart. The bounding box 308 is associated with a set of coordinate(s) 310.

A set of one or more depth estimation model(s) 312 generate a set of one or more depth map(s) 314 for each image in the plurality of images associated with the image data 304. The depth estimation model(s) 312 include one or more models, such as, but not limited to, the depth estimation model 130 in FIG. 1.

A per-cart depth determination component 316 combines the bounding box data and the depth map(s) 314 into per-cart depth data. The per-cart depth determination component 316 uses the per-cart depth data to generate a customized per-cart depth value. A normalization component 320 normalizes the per-cart depth value(s) 318 to generate normalized depth value(s) 322 for each detected cart in each image.

The depth value can be calculated because the system knows the approximate location of each cart in the image based on the bounding box coordinates for each cart and the distance information for each cart in the depth map. The depth values are initially unbounded and can include any values, such as, but not limited to, values between 100 or 1,000. Normalization enables bounding of the depth values between a predetermined range of values, such as, but not limited to, a range between zero and one [0,1].

A set of one or more classification model(s) 324 includes one or more ML models for identifying and labeling active and inactive carts. The set of classification model(s) 324 includes a classification model, such as, but not limited to, the classification model 134 in FIG. 1. The classification model(s) separates out the active carts from the inactive carts and generates an active cart label 326 for each active cart identified at each checkout terminal. The classification model(s) 326 annotate the image data 304 with one or more inactive cart label(s) 328 corresponding to each inactive cart identified in the image data 304.

A prediction component 330 generates a predicted active cart 332 within a user-selected range 334 of the checkout terminal. The predicted active cart is included in one or more result(s) 338 generated by a notification component 336 in this example. The result(s) 338 are output to a user via a user interface or otherwise provided to another application for further utilization in identifying carts, cart contents, verifying all items in a cart are scanned, and/or matching a cart receipt to a cart.

FIG. 4 is an exemplary flow chart illustrating operation of the computing device to identify an active cart from a plurality of carts captured in an image. The process 400 shown in FIG. 4 is performed by a cart separation manager component, executing on a computing device, such as the computing device 102 in FIG. 1 and FIG. 2.

The process begins by analyzing an image at 402. The image is generated by a bottom camera, such as, but not limited to, a bottom camera in the image capture device(s) 116 in FIG. 1 and/or the bottom camera 214 in FIG. 2. The cart separation manager obtains bounding boxes for carts in the image at 404. The bounding boxes are obtained from a computer vision object detection model, such as, but not limited to, the cart detection model 124 in FIG. 1 and/or the cart detection model(s) 302 in FIG. 3.

The cart separation manager combines the bounding boxes with a depth map for the image at 406. The depth map is generated by a depth estimation model, such as, but not limited to, the depth estimation model 130 in FIG. 1 and/or the depth estimation model(s) 312 in FIG. 3. The cart separation manager generates depth values for each cart using the depth map and the bounding boxes for each detected cart at 408. The cart separation manager normalizes the depth values at 410. The cart separation manager determines whether an active cart is identified in the image data for the image at 412. If not, the system terminates thereafter.

If an active cart is identified at 412, the cart separation manager identifies a predicted active cart in the plurality of carts in the image at 414. The predicted active cart is labeled in the image data and/or included in an output result. The process terminates thereafter.

While the operations illustrated in FIG. 4 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 4.

FIG. 5 is an exemplary flow chart illustrating operation of the computing device to infer an active cart based on object detection and depth estimation results. The process 500 shown in FIG. 5 is performed by a cart separation manager component, executing on a computing device, such as the computing device 102 in FIG. 1 and FIG. 2.

The process begins by obtaining cart images from an image capture device at 502. In this example, the image capture device is a bottom camera associated with a bottom portion of a checkout terminal. The images include multiple carts within the FOV of the image capture device. The cart separation manager performs object detection to detect the carts in the images at 504. The object detection is performed using a pre-trained object detection model trained to detect shopping carts, such as, but not limited to, the cart detection model 124 in FIG. 1 and/or the cart detection model(s) 302 in FIG. 3.

The cart separation manager obtains bounding boxes for each detected cart at 506. The cart separation manager generates depth values for each detected cart using the bounding boxes and depth map(s) for each image at 508. The cart separation manager identifies a decision boundary at 510. The decision boundary is used to determine a depth value threshold. The depth values and decision boundary is used to infer an active cart at 512. The process terminates thereafter.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

FIG. 6 is an exemplary flow chart illustrating operation of the computing device to label an active cart in an image including a plurality of carts using cart detection bounding boxes and a depth map. The process 600 shown in FIG. 6 is performed by a cart separation manager component, executing on a computing device, such as the computing device 102 in FIG. 1 and FIG. 2.

The process begins by obtaining cart images from an image capture device at 602. The cart separation manager performs depth estimation at 604 and generates depth map(s) for the images at 606. The cart separation manager generates multi-cart data set using the cart bounding boxes and depth map(s) at 608. A classification model classifies the active carts and inactive carts at 610. The cart separation manager labels the active cart in each image at 612. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

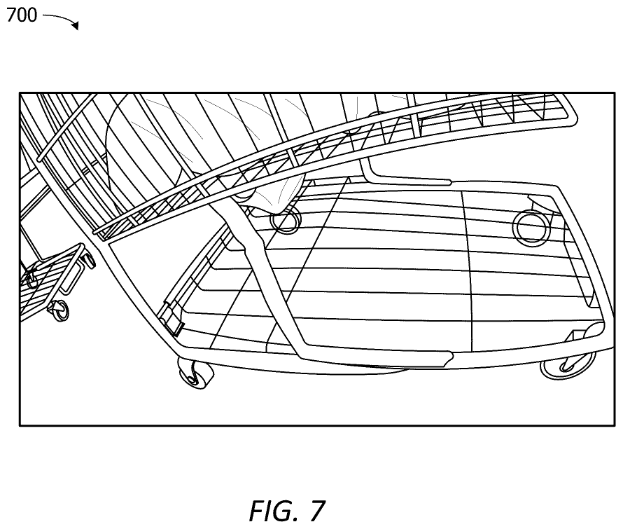

Referring now to FIG. 7, an exemplary unannotated image 700 of a bottom portion of an active cart in a multi-cart data set is shown. In this example, the image 700 is an image of a bottom portion of an active cart in the foreground with a partial image of an inactive cart in the background. The active cart includes a set of items in the active cart.

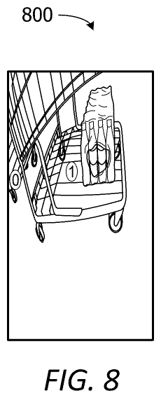

FIG. 8 is an exemplary annotated image 800 of a bottom portion of an active cart and an inactive cart. In this example, the image 800 is an annotated image of a bottom portion of an active cart having a one label “1” overlaid on the image of the active cart and a portion of a bottom of an inactive cart having a label of zero “0” overlaid on the portion of the inactive cart. The active cart includes a set of items in the active cart.

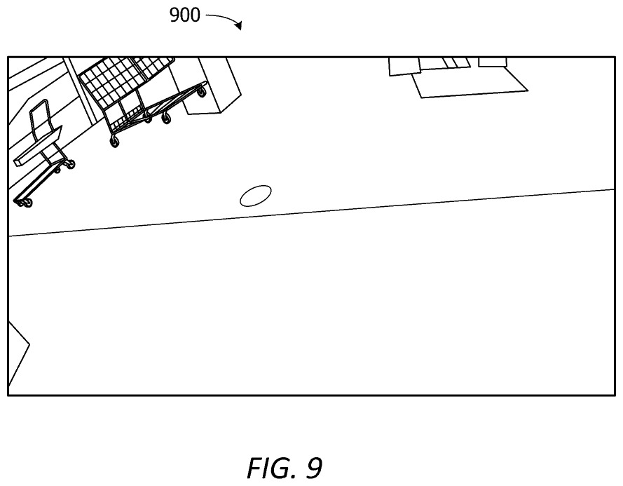

Referring now to FIG. 9, an exemplary unannotated image 900 of a bottom portion of two inactive carts in an absence of an active cart is shown. In this example, the image 900 includes the bottom portion of the two inactive carts in the background of the image.

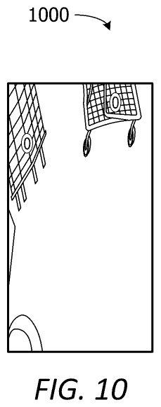

FIG. 10 is an exemplary annotated image 1000 of a bottom portion of two inactive carts in an absence of an active cart. In this example, the image 1000 includes an overlay with a “0” annotation on a first inactive cart and another “0” annotation corresponding to a second inactive cart. There is no active cart within the image 1000. In this example, none of the carts are present within the threshold range of the checkout terminal in this example. The image 1000 includes two inactive cart labels overlaid on the two inactive carts. No active cart is visible in the image 1000. In this example, the images shown in FIG. 7, FIG. 8, FIG. 9, and FIG. 10 are included in a multi-cart data set for images generated by a single bottom camera.

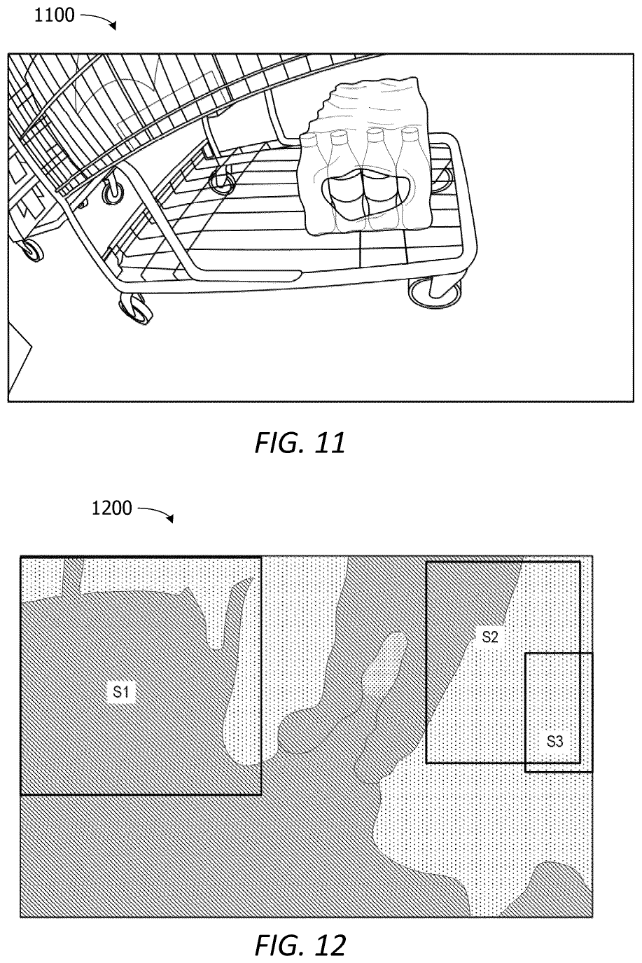

FIG. 11 is an exemplary image 1100 of a bottom portion of an active cart without any inactive carts present in the image. The active cart includes a set of items on the cart. The active cart is located within a threshold range of the checkout terminal.

FIG. 12 is an exemplary depth map 1200 associated with an image of a plurality of carts generated by a depth estimation model. The depth map 1200 includes distance information for three objects within the image. The system merges the cart bounding box with the depth map to obtain a normalized depth value for every cart inside the bottom image where the depth value is determined in accordance with the following:

dᵢ=sⁱ/S

where dᵢ is the depth value for each cart, S is the depth of the whole image, and sᵢ is the sum of all the depths. The depth value for a given cart is a value between one and zero. In this manner, the depth values are bounded within a region.

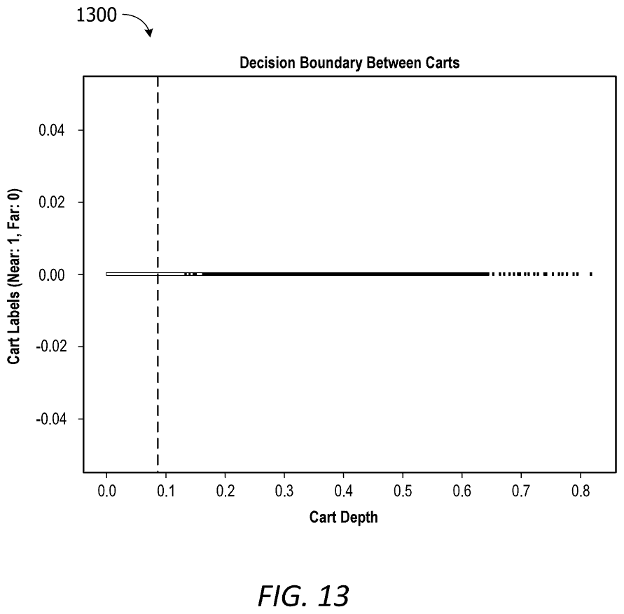

FIG. 13 is an exemplary line graph 1300 for a depth threshold determination in accordance with a multi-cart data set. The graph 1300 shows a decision boundary between carts used to determine a depth threshold applied to the per-cart depth value(s) calculated using the depth map and bounding boxes for each cart detected in a given image. The decision boundary (i.e., depth threshold) is determined by the classification model. The misclassification rate is as low as 0.045 in this example.

In this example, the classification model is a support vector machine. However, the embodiments are not limited to a support vector machine. The system is flexible and can accommodate any classifier model capable of determining this decision boundary.

### ADDITIONAL EXAMPLES

In some embodiments, the system performs multi-cart separation with depth estimation and object detection. A cart separation manager gathers images containing multiple shopping carts from a bottom camera at each checkout terminal. The system creates annotations for the multi-cart dataset. For example, the system can assign a label of one (1) to the active checkout cart and a label of zero (0) to the inactive checkout cart. The system utilizes a pre-trained shopping cart detection model to perform inference on the bottom camera images, obtaining bounding boxes for all shopping carts in the images. The system employs a pre-trained monocular depth estimation model to perform inference on the bottom camera images and generate corresponding depth maps.

The system, in other embodiments, combines the shopping cart bounding boxes with the depth map to determine a depth value for each shopping cart. To normalize the depth values, as the depth map is usually unbounded, the system uses region information to constrain the values within the range [0, 1] for each shopping cart. The system utilizes a classification model (e.g., support vector machine) to classify the multi-cart dataset based on depth values. The determined decision boundary serves as the threshold to differentiate the checking cart from other unchecked carts.

In other examples, the system ensures that the model can effectively monitor and analyze images of one cart at a time. This becomes challenging when relying solely on the top view camera, particularly during busy hours in retail stores. To address this issue, the system introduces the use of a bottom camera, along with depth estimation and object detection techniques, providing a robust approach to tackle this problem. Instead of relying on unbounded depth values from the depth estimation model, the system performs novel region-based depth normalization techniques that enhance the cart separation process, improving reliability and accuracy in identifying an active cart from a plurality of carts. The novel multi-cart dataset includes annotations for both active and inactive checkout carts, paving the way for more advanced research and developments in this domain.

In an example scenario, a bottom camera captures an image of multiple carts near a checkout terminal. The system analyses the image to detect the carts and generate a depth map. The detected cart bounding boxes and depth maps are used to generate normalized depth values for each cart. The cart located within a threshold range (having a threshold depth) of the checkout terminal is identified as the active cart. The non-active (inactive) carts are discarded. Only the items in the active cart are identified for further use, such as verifying cart contents, matching a receipt to the cart, etc.

Alternatively, or in addition to the other examples described herein, examples include any combination of the following:
create a set of annotations for the multi-cart dataset, the set of annotations comprising an active cart label and a set of inactive cart labels;
assign, by a classification model, an active cart label to the identified active cart in image data associated with the image;
assign an inactive cart label to each cart in the set of inactive carts identified using the image data;
wherein the active cart label is a “1” label, and wherein the inactive cart label is a “0” label annotated in the image data;
obtain a plurality of images of the plurality of carts from the image capture device, wherein the image capture device is a bottom camera associated with the checkout terminal;
generate bounding boxes around each cart in the plurality of carts in each image in the plurality of images;
generate a plurality of depth maps for all carts in the plurality of images;
identify a predicted active cart and the set of predicted inactive carts in each image in the plurality of images using the plurality of depth maps and the bounding boxes for each image in the plurality of images;
normalize the set of depth values using region information associated with the region to constrain the depth values within a range from [0] to [1] for each detected cart;
classify a multi-cart dataset associated with the plurality of carts detected in a plurality of images based on the set of depth values, by the classification model;
apply a threshold to differentiate the active cart from the set of inactive carts, wherein a decision boundary serves as the threshold;
analyzing an image generated by an image capture device associated with a checkout terminal by a pre-trained cart detection model and a depth estimation model in real-time;
obtaining, from a pre-trained shopping cart detection model, a set of bounding boxes identifying the plurality of carts captured in the image;
combining the set of bounding boxes with a depth map associated with the plurality of carts in the image, the depth map generated by a depth estimation model;
generating a plurality of depth values corresponding to each detected cart in the set of detected carts using a multi-cart data set comprising the combined set of bounding boxes and the depth map;
identifying an active cart located within a predetermined range of the checkout terminal and a set of inactive carts within the plurality of carts, wherein the active cart is a cart comprising a set of items currently checking out at the checkout terminal;
associating a receipt corresponding to the set of items purchased by a customer at the checkout terminal with the active cart;
creating a set of annotations for the multi-cart dataset, the set of annotations comprising an active cart label and a set of inactive cart labels;
assigning, by a classification model, an active cart label to the identified active cart in image data associated with the image;
assigning an inactive cart label to each cart in the set of inactive carts identified using the image data, wherein the active cart label is a “1” label, and wherein the inactive cart label is a “0” label annotated in the image data;
obtaining a plurality of images of the plurality of carts from the image capture device, wherein the image capture device is a bottom camera associated with the checkout terminal;
generating bounding boxes around each cart in the plurality of carts in each image in the plurality of images;
generating a plurality of depth maps for all carts in the plurality of images;
identifying a predicted active cart and the set of predicted inactive carts in each image in the plurality of images using the plurality of depth maps and the bounding boxes for each image in the plurality of images;
normalizing the set of depth values using region information associated with the region to constrain the depth values within a range from [0] to [1] for each detected cart;
classifying a multi-cart dataset associated with the plurality of carts detected in a plurality of images based on the set of depth values, by the classification model;
applying a threshold to differentiate the active cart from the set of inactive carts, wherein a decision boundary serves as the threshold;
analyze the image from the image capture device associated with the checkout terminal by a pre-trained cart detection model and a depth estimation model in real-time;
obtain, from a pre-trained shopping cart detection model, a set of bounding boxes identifying a set of detected carts in the plurality of carts captured in the image;
obtain a depth map associated with the plurality of carts in the image from the depth estimation model;
generate a plurality of depth values corresponding to each detected cart in the set of detected carts using the set of bounding boxes and the depth map;
normalize each depth value in the plurality of depth values using region information associated with the image to constrain the depth values within a predetermined range for each cart in the plurality of carts;
identify an active cart located within a predetermined range of the checkout terminal and a set of inactive carts within the plurality of carts using the normalized plurality of depth values, wherein the active cart is a cart comprising a set of items currently checking out at the checkout terminal;
annotate the multi-cart dataset using a set of labels, wherein an active cart label identifies the active cart in each image in a plurality of images, and wherein an inactive cart label identifies each inactive cart in each image in the plurality of images;
assigning an active cart label to the active cart in image data associated with the image, wherein the active cart is located within a predetermined proximity to the checkout terminal based on the depth values;
assign an inactive cart label to an inactive cart identified based on the depth values;
generate a customized threshold associated with the multi-cart dataset, wherein the threshold is generated based on a decision boundary;
apply the customized threshold to differentiate the active cart from the set of inactive carts, wherein a decision boundary serves as the threshold;
constrain the depth values within a range from [0] to [1] for each detected cart to normalize the depth values, wherein the normalized depth values are used to identify the active cart;
generate, by the image capture device, a plurality of images of the plurality of cart, wherein the image capture device is a bottom camera associated with the checkout terminal;
obtain a set of coordinates for each bounding box in a plurality of bounding boxes corresponding to each detected cart in the plurality of carts in each image in the plurality of images;
obtain a depth map in a plurality of depth maps for each image in the plurality of images; and
predict an active cart in each image in the plurality of images using the plurality of depth maps and the set of coordinates for each bounding box for each image in the plurality of images, wherein any inactive carts in each image are discarded.

At least a portion of the functionality of the various elements in FIG. 1, FIG. 2 and FIG. 3 can be performed by other elements in FIG. 1, FIG. 2, and FIG. 3, or an entity (e.g., processor 106, web service, server, application program, computing device, etc.) not shown in FIG. 1, FIG. 2, and FIG. 3.

In some examples, the operations illustrated in FIG. 4, FIG. 5, and FIG. 6 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of separating active carts and inactive carts using object detection and depth maps, the method comprising analyzing an image generated by an image capture device associated with a checkout terminal by a pre-trained cart detection model and a depth estimation model in real-time; obtaining, from a pre-trained cart detection model, a set of bounding boxes identifying a plurality of carts captured in the image; combining the set of bounding boxes with a depth map associated with the plurality of carts in the image, the depth map generated by a depth estimation model; generating a plurality of depth values corresponding to each detected cart in the set of detected carts using a multi-cart data set comprising the combined set of bounding boxes and the depth map; and identifying an active cart located within a predetermined range of the checkout terminal and a set of inactive carts within the plurality of carts, wherein the active cart is a cart comprising a set of items currently checking out at the checkout terminal.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for multi-cart separation using computer vision and depth estimation. For example, the elements illustrated in FIG. 1, FIG. 2, and FIG. 3, such as when encoded to perform the operations illustrated in FIG. 4, FIG. 5, and FIG. 6, constitute exemplary means for analyzing an image generated by an image capture device associated with a checkout terminal by a pre-trained cart detection model and a depth estimation model in real-time; exemplary means for generating a set of bounding boxes identifying a plurality of carts captured in the image; exemplary means for combining the set of bounding boxes with a depth map associated with the plurality of carts in the image, the depth map generated by a depth estimation model; generating a plurality of depth values corresponding to each detected cart in the set of detected carts using a multi-cart data set comprising the combined set of bounding boxes and the depth map; and identifying an active cart located within a predetermined range of the checkout terminal and a set of inactive carts within the plurality of carts, wherein the active cart is a cart comprising a set of items currently checking out at the checkout terminal.

Other non-limiting examples provide one or more computer storage devices having a first computer-executable instructions stored thereon for providing multi-cart active cart separation. When executed by a computer, the computer performs operations including analyze the image from the image capture device associated with a checkout terminal by a pre-trained cart detection model and a depth estimation model in real-time; obtain, from a pre-trained cart detection model, a set of bounding boxes identifying a set of detected carts in a plurality of carts captured in the image; obtain a depth map associated with the plurality of carts in the image from the depth estimation model; generate a plurality of depth values corresponding to each detected cart in the set of detected carts using the set of bounding boxes and the depth map; normalize each depth value in the plurality of depth values using region information associated with the image to constrain the depth values within a predetermined range for each cart in the plurality of carts; and identify an active cart located within a predetermined range of the checkout terminal and a set of inactive carts within the plurality of carts using the plurality of normalized depth values, wherein the active cart is a cart comprising a set of items currently checking out at the checkout terminal.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for multi-cart separation using computer vision and depth estimation, the system comprising:
an image capture device associated with a checkout terminal, the image capture device generating an image of a bottom portion of a plurality of carts within a field of view of the image capture device;
a computer-readable medium storing instructions that are operative upon execution by a processor to:
analyze the image from the image capture device associated with the checkout terminal by a pre-trained cart detection model and a depth estimation model in real-time;
obtain, from the pre-trained cart detection model, a set of bounding boxes associated with each cart in the plurality of carts captured in the image;
obtain a depth map associated with the plurality of carts in the image from the depth estimation model;
generate a plurality of depth values corresponding to each cart in the plurality of carts using the set of bounding boxes and the depth map; and
identify an active cart located within a predetermined range of the checkout terminal and a set of inactive carts within the plurality of carts, wherein the active cart is a cart comprising a set of items currently checking out at the checkout terminal.

2. The system of claim 1, wherein the instructions are further operative to:
create a set of annotations for a multi-cart data set, the set of annotations comprising an active cart label and a set of inactive cart labels.

3. The system of claim 1, wherein the instructions are further operative to:
assign, by a classification model, an active cart label to the identified active cart in image data associated with the image; and
assign an inactive cart label to each cart in the set of inactive carts identified using the image data.

4. The system of claim 3, wherein the active cart label is a “1” label, and wherein the inactive cart label is a “0” label annotated in the image data.

5. The system of claim 1, wherein the instructions are further operative to:
obtain a plurality of images of the plurality of carts from the image capture device, wherein the image capture device is a bottom camera associated with the checkout terminal;
generate bounding boxes around each cart in the plurality of carts in each image in the plurality of images;
generate a plurality of depth maps for all carts in the plurality of images; and
identify a predicted active cart and a set of predicted inactive carts in each image in the plurality of images using the plurality of the depth maps and the bounding boxes for each image in the plurality of images.

6. The system of claim 1, wherein the instructions are further operative to:
normalize the set of depth values using region information associated with the image to constrain the depth values within a range from [0] to [1] for each detected cart.

7. The system of claim 1, wherein the instructions are further operative to:
classify a multi-cart data set associated with the plurality of carts detected in a plurality of images based on the set of depth values, by a classification model; and
apply a threshold to differentiate the active cart from the set of inactive carts, wherein a decision boundary is used to generate the threshold.

8. A method for multi-cart separation using computer vision and depth estimation, the method comprising:
analyzing an image generated by an image capture device associated with a checkout terminal by a pre-trained cart detection model and a depth estimation model in real-time;
generating, from the pre-trained cart detection model, a set of bounding boxes identifying a plurality of carts captured in the image;
combining the set of bounding boxes with a depth map associated with the plurality of carts in the image, the depth map generated by the depth estimation model;
calculating a plurality of depth values corresponding to each cart in the plurality of carts using a multi-cart data set comprising the combined set of bounding boxes and the depth map; and
identifying an active cart located within a predetermined range of the checkout terminal and a set of inactive carts within the plurality of carts, wherein the active cart is a cart comprising a set of items currently checking out at the checkout terminal.

9. The method of claim 8, further comprising:
associating a receipt corresponding to the set of items purchased by a customer at the checkout terminal with the active cart.

10. The method of claim 8, further comprising:
creating a set of annotations for the multi-cart data set, the set of annotations comprising an active cart label and a set of inactive cart labels.

11. The method of claim 8, further comprising:
assigning, by a classification model, an active cart label to the identified active cart in image data associated with the image; and
assigning an inactive cart label to each cart in the set of inactive carts identified using the image data, wherein the active cart label is a “1” label, and wherein the inactive cart label is a “0” label annotated in the image data.

12. The method of claim 8, further comprising:
obtaining a plurality of images of the plurality of carts from the image capture device, wherein the image capture device is a bottom camera associated with the checkout terminal;
generating bounding boxes around each cart in the plurality of carts in each image in the plurality of images;
generating a plurality of depth maps for all carts in the plurality of images; and
identifying a predicted active cart and a set of predicted inactive carts in each image in the plurality of images using the plurality of the depth maps and the bounding boxes for each image in the plurality of images.

13. The method of claim 8, further comprising:
normalizing the set of depth values using region information associated with the image to constrain the depth values within a range from [0] to [1] for each detected cart in the image.

14. The method of claim 8, further comprising:
classifying the multi-cart data set associated with the plurality of carts detected in a plurality of images based on the set of depth values, by a classification model; and
applying a threshold to differentiate the active cart from the set of inactive carts, wherein a decision boundary serves as the threshold.

15. One or more computer storage devices having computer-executable instructions stored thereon, which, upon execution by a computer, cause the computer to perform operations comprising:
analyze an image from an image capture device associated with a checkout terminal by a pre-trained cart detection model and a depth estimation model in real-time, the image comprising a plurality of carts;
obtain, from the pre-trained cart detection model, a set of bounding boxes associated with each cart in the plurality of carts captured in the image;
obtain a depth map associated with the plurality of carts in the image from the depth estimation model;
generate a plurality of depth values corresponding to each cart in the plurality of carts using the set of bounding boxes and the depth map;
normalize each depth value in the plurality of depth values using region information associated with the image to constrain the depth values within a predetermined range for each cart in the plurality of carts; and
identify an active cart located within the predetermined range of the checkout terminal and a set of inactive carts within the plurality of carts using the plurality of normalized depth values, wherein the active cart is a cart comprising a set of items currently checking out at the checkout terminal.

16. The one or more computer storage devices of claim 15, wherein the operations further comprise:
annotate a multi-cart data set using a set of labels, wherein an active cart label identifies the active cart in each image in a plurality of images, and wherein an inactive cart label identifies each inactive cart in each image in the plurality of images.

17. The one or more computer storage devices of claim 15, wherein the operations further comprise:
assigning an active cart label to the active cart in image data associated with the image, wherein the active cart is located within a predetermined proximity to the checkout terminal based on the depth values; and
assign an inactive cart label to an inactive cart identified based on the depth values.

18. The one or more computer storage devices of claim 15, wherein the operations further comprise:
generate a customized threshold associated with a multi-cart data set using a decision boundary, wherein the customized threshold is generated based on the decision boundary; and
apply the customized threshold to differentiate the active cart from the set of inactive carts.

19. The one or more computer storage devices of claim 15, wherein the operations further comprise:
constrain the depth values within a range from [0] to [1] for each detected cart to normalize the depth values, wherein the normalized depth values are used to identify the active cart.

20. The one or more computer storage devices of claim 15, wherein the operations further comprise:
generate, by a bottom camera, a plurality of images of the plurality of carts, wherein the image capture device is the bottom camera associated with the checkout terminal;
obtain a set of coordinates for each bounding box in a plurality of bounding boxes corresponding to each detected cart in the plurality of carts in each image in the plurality of images;
obtain a depth map in a plurality of depth maps for each image in the plurality of images; and
predict the active cart in each image in the plurality of images using the plurality of the depth maps and the set of coordinates for each bounding box for each image in the plurality of images, wherein any inactive carts in each image are discarded.
